(19) United States
(12) Patent Application Publication
(10) Pub. No.: US 2009/0121470 A1
(43) Pub. Date: May 14, 2009

(54) Wallet Size Bank Card Booklet

(76) Inventors: William B. Exline, Chagrin Falls, OH (US); Christopher P. Exline, Chagrin Falls, OH (US); Michael P. Exline, Novelty, OH (US); Walter M. Beaton, Parma, OH (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/939,857

(22) Filed: Nov. 14, 2007

(51) Int. Cl. B42D 3/00; B32B 38/04

(52) U.S. Cl. 281/31; 156/250

(57) ABSTRACT

A wallet size bank card booklet is provided, and a method for forming the same, having a cover and a booklet insert. The cover has a width dimension ranging from about 4¾ inches to 5¼ inches and a height dimension ranging from about 3⅜ inches to 3⅜ inches. A transverse fold divides the cover into a front cover panel and a rear cover panel. The booklet insert in the form of a number of leaves has dimensions substantially the same as the dimensions of the cover, the leaves also having a transverse fold and forming pages. An opening is formed in the front cover panel. An adhesive layer is applied to the inner surface of the front cover panel and a transparent sheet is adhered to the inner surface of the front cover panel, the transparent sheet being larger than the opening, but shorter and narrower than the front panel, leaving an L-shaped marginal adhesive along two adjacent edges of the inner surface of the front panel. A pocket is formed by a first leaf being sealed along two edges to the L-shaped marginal adhesive area on the inner surface of the front panel, with a third edge adjacent the fold and a forth edge remaining open.

### FIELD OF THE INVENTION

The present invention relates generally to a booklet for recording information, such as bank transactions, expenses, mileage, appointments, schedules, and the like, and more particularly, to a wallet size card booklet having a pocket with a transparent window formed therein a front cover. The pocket is large enough to hold and display a conventional size bank card, but the booklet itself is small enough to fit within one of the conventional card compartments of a wallet.

### BACKGROUND

As the technology related to information, identification, sales, banking, and the like have proliferated in recent years, so have the numbers and types of identification cards, credit cards, debit cards, smart cards, etc. (hereafter referred to as “bank cards”). Most all of these cards have been produced in the conventional credit card size so that they can be carried in the same wallet pockets as the credit cards. These cards are referred to as CR80 (3⅜-2⅛ inches) and generally are 0.015-0.033 inches thick.

While this plethora of cards has made many aspects of daily life more convenient and transactions less time consuming for users “on the go,” other means have become necessary for recording transactions, instructions, reservations, directions, etc. Thus, various holders, booklets, and folders have been introduced having card inserts or pockets and one or more spaces to record information or transactions. Unfortunately, their introduction has created a situation where users have just one more article to carry separately.

In more recent years, wallet size card books have been provided having pockets large enough to fit a credit card sized card, but yet small enough so that the entire booklet may fit into the credit card compartment of a conventional wallet.

### SUMMARY OF THE INVENTION

Applicant(s) recognized the various problems and have created a type of booklet which overcomes them. Applicant(s) have also noted that while these wallet size books have at least eliminated the problem of having an additional separate article to carry, producing one of the cards itself, for identification purposes or for quick access to the information on the face of the card, still requires that the card be removed from the pocket or sleeve of the card booklet for such purposes.

Further, as the uses of smart cards and the like have expanded, so have the sensitivity of these cards to magnetic fields, electrostatic exposure, and electronic devices in close proximity. Accordingly, materials such as plastics having a greater than normal propensity for static accumulation, have been found to disrupt or even permanently alter the magnetic properties of these cards.

There has also been developed a method for making such booklets utilizing mass production techniques.

One aspect of the present invention relates to an improved wallet size booklet for holding bank cards, and to a method for forming the same. More particularly, the embodiments described herein provide a bank card booklet having a pocket which is large enough to hold a standard bank card, and yet is sufficiently compact to fit within the conventional card compartment of a wallet. A transparent window is formed in one of the front or rear cover panels of the booklet so that substantially all of the information on the front of the bank card is visible without having to open and/or remove the bank card from the pocket within the booklet. To ensure that the magnetic properties of the bank card are not altered or disrupted through use of the booklet, an anti-static material forms the transparent window.

A first aspect of the invention is directed to a wallet size bank card booklet comprising a cover having a card pocket, a transparent window into the pocket, and a booklet insert. The cover is formed of a cover material having a width dimension ranging from 4¾ inches to 5¼ inches (5 inches being preferred) and a height dimension ranging from 3⅜ inches to 3⅝ inches (3½ inches being preferred). A transverse fold divides the cover into a front cover panel and a rear cover panel, each panel having outer and inner surfaces. The booklet insert is in the form of a plurality of leaves formed of a different material from the cover and having dimensions substantially the same as the dimensions of the cover. The leaves also are divided along a transverse fold, forming pages. The cover and the booklet insert are attached in such as manner that the fold of the cover and the fold of the leaves are contiguous. The completed folded booklet then has a dimension of about 2½ inches×3½ inches.

An opening is cut in the front cover panel, and an adhesive layer is applied to at least the inner surface of the front cover panel. A transparent sheet is then adhered to the inner surface of the front cover panel, the transparent sheet being larger than the opening, but shorter and narrower than the front panel, thereby forming a window. One side edge of the transparent sheet is positioned adjacent the fold, leaving an L-shaped marginal adhesive area along two adjacent edges of the inner surface of the front panel. A pocket is formed by a first leaf of the booklet insert being sealed along two edges to the L-shaped marginal adhesive area on the inner surface of the front panel. The third edge is actually the transverse fold and the fourth edge is unattached, forming the opening of the pocket, In one embodiment, the transparent sheet is an anti-static clear polyester.

A second aspect of the invention is directed to one method of forming the wallet size bank card booklet. A cover for the booklet is formed, and an opening is cut into either the front cover panel, rear cover panel, or both. A booklet insert is also formed by assembling a plurality of printed leaves. The booklet is then laid face down in the assembly area, and a transparent sheet is positioned on the first leaf. A cover is then moved across an adhesive roll where adhesive is next applied to the inner surface of the front cover panel. The cover is then moved to a position above the booklet and pressed downwardly onto the booklet and transparent sheet. The transparent sheet material becomes adhered to the inner surface of the front cover panel over the adhesive forming a window. Again, in certain embodiments, the transparent sheet is cut shorter and narrower than the inner front panel, having one side edge adhered at the fold and leaving an L-shaped adhesive area exposed on the inner surface of the front panel. The booklet insert is simultaneously attached to the cover in such a manner that the fold lines of the cover and booklet insert coincide. The pocket of the booklet is created by sealing the first leaf of the assembled leaves along two edges to the exposed L-shaped adhesive area on the inner surface of the front panel. A third, inner edge of the front leaf is attached to the cover at the fold and a fourth edge remains open to receive a conventional bank card. In one embodiment, the last leaf of the assembled leaves may be adhered to the inside surface of the rear cover panel to complete the booklet. Alternatively, a pocket with or without a window may be formed by the rear cover panel and the last leaf of the booklet insert. The booklets are then folded.

Yet another aspect of the invention is in the method by which a plurality of booklets can be formed at once, then separated into a plurality of booklets.

These and other aspects of the present invention will become apparent to those skilled in the art after a reading of the following description, when considered with the drawings.

### BRIEF DESCRIPTION OF THE DRAWINGS

FIG. 1 is a perspective view of one embodiment of the wallet size bank card booklet of the present invention with a transparent window in the front cover panel.

FIG. 2 is a outside elevational view of the front cover panel only of the embodiment of FIG. 1.

FIG. 3 is inside elevational view of the front cover panel only of the embodiment of FIG. 1.

FIG. 4 is an exploded perspective view of the embodiment of FIG. 1.

FIG. 5 is a perspective view of the wallet size bank card booklet in an open position with the first leaf separated from the front cover panel.

FIG. 6 is a perspective view of the wallet size bank card booklet in an open position with the first leaf adhered to the front cover panel to form a pocket.

FIG. 7 is an alternative embodiment of the wallet size bank card booklet, having a pocket formed in both the front and rear cover panels.

FIG. 8 is an exploded view illustrating the production and assembly of a plurality of booklets.

### DETAILED DESCRIPTION

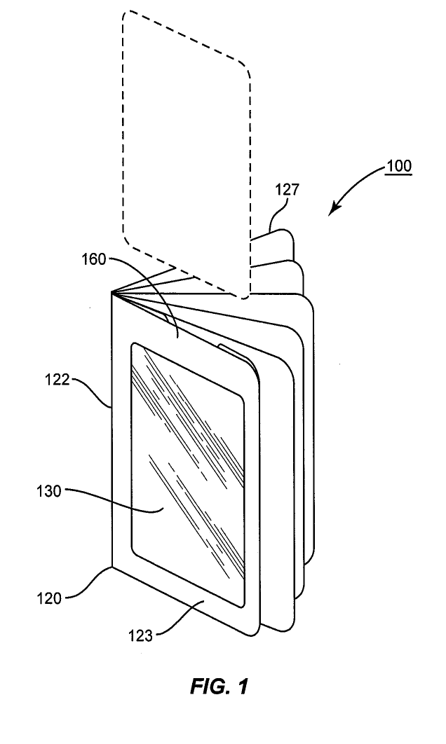

Referring now to the Figures in general, and to FIG. 1 in particular, it will be understood that the illustrations and descriptions herein are for the purpose of describing certain embodiments of the present invention and are not intended to limit the invention hereto. One aspect of the present invention is directed to a wallet size bank card booklet. Alternatively, another aspect of the present invention is directed to the method of forming the wallet size bank card booklet.

Shown generally as 100 in the Figures, the wallet size card booklet 100 comprises a cover 120 that is formed from a suitable cardstock material such as a treated paper substrate which is commercially available under the name LEXIDE®. LEXIDE® or similarly suitable material comprises a non-woven cover stock of fibers that are intermixed, or impregnated, with a rubber or latex component; however, as will be appreciated, any strong and pliable cover material is suitable for the embodiments described herein.

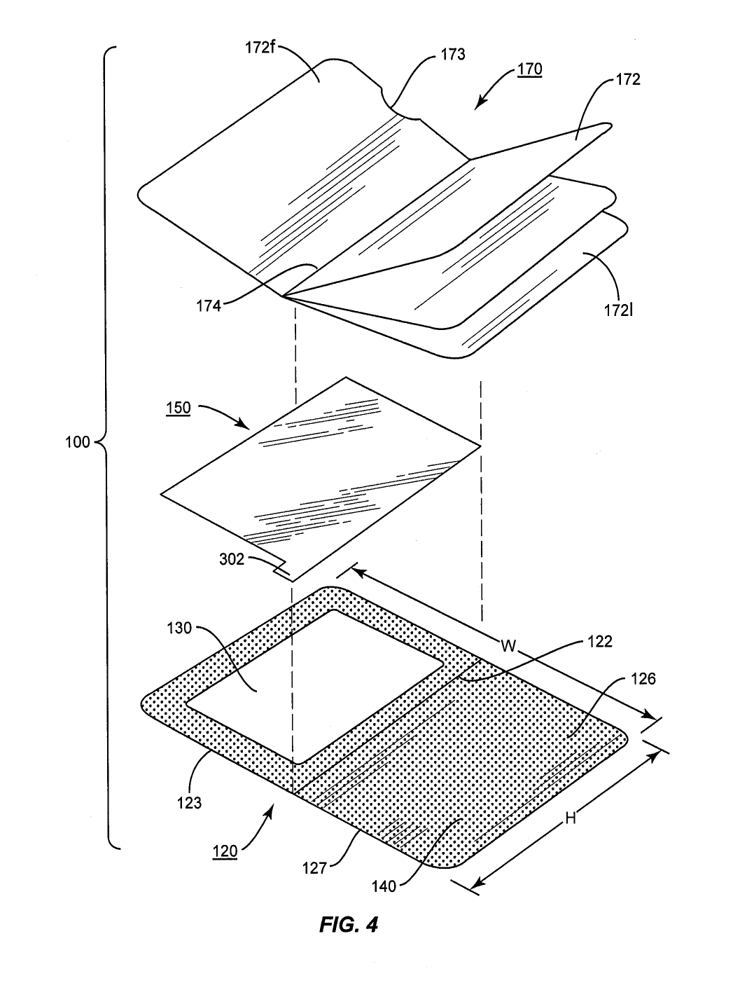

The cover 120 may be die cut from a larger cover stock material to economically produce the cover 120; e.g., four or more similarly sized covers 120 may be die cut from a standard sized sheet; i.e., 11 inches×17 inches. Each die cut cover 120 has a width, W, (with the cover spread open) of between about 4¾ inches and 5¼ inches and a height, H, dimension of between about 3⅜ inches and 3⅝ inches. As shown in FIGS. 1 and 4, the cover 120 is folded along a transverse fold 122 which divides the cover 120 into a front cover panel 123 and a rear cover panel 127. Each panel 123, 127 has a width corresponding to one-half the width (approximately 2½ inches) of the total width W of the cut cover 120. While the covers 120 of the embodiments shown and described herein are formed of a single substrate, it will be appreciated that the cover may be made of separate panels that are bound by any appropriate means along a common fold line 122.

Each of the front 123 and rear 127 panels has an outer and inner surface. As described below, an arcuate recess is formed in the leaf 172f comprising the inside portion of the pocket to facilitate the insertion and removal of a bank card. Additionally, the booklet 100 has upper and lower rounded corners opposite the transverse fold 122. The rounded corners are between about ⅛ inches and ¼ inches in radius.

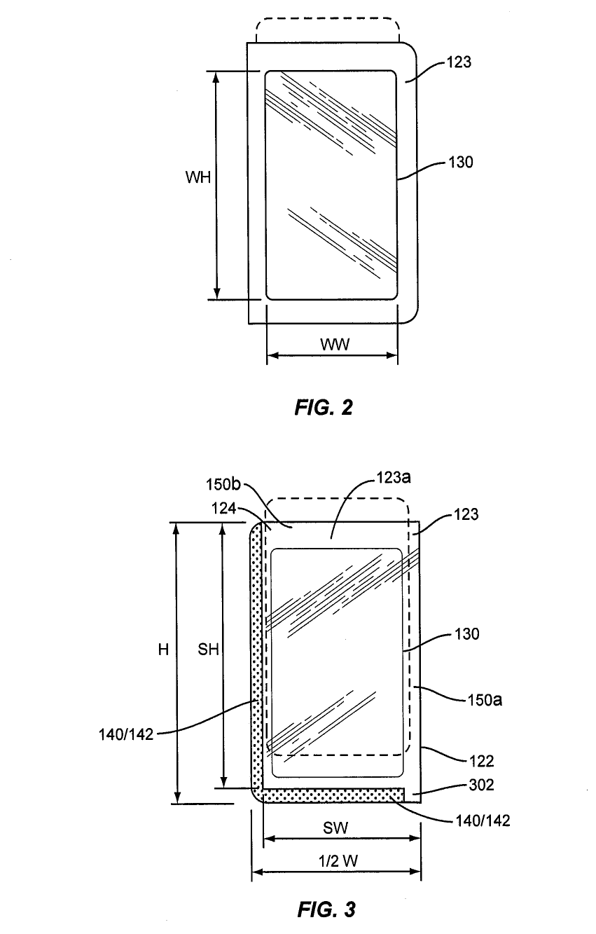

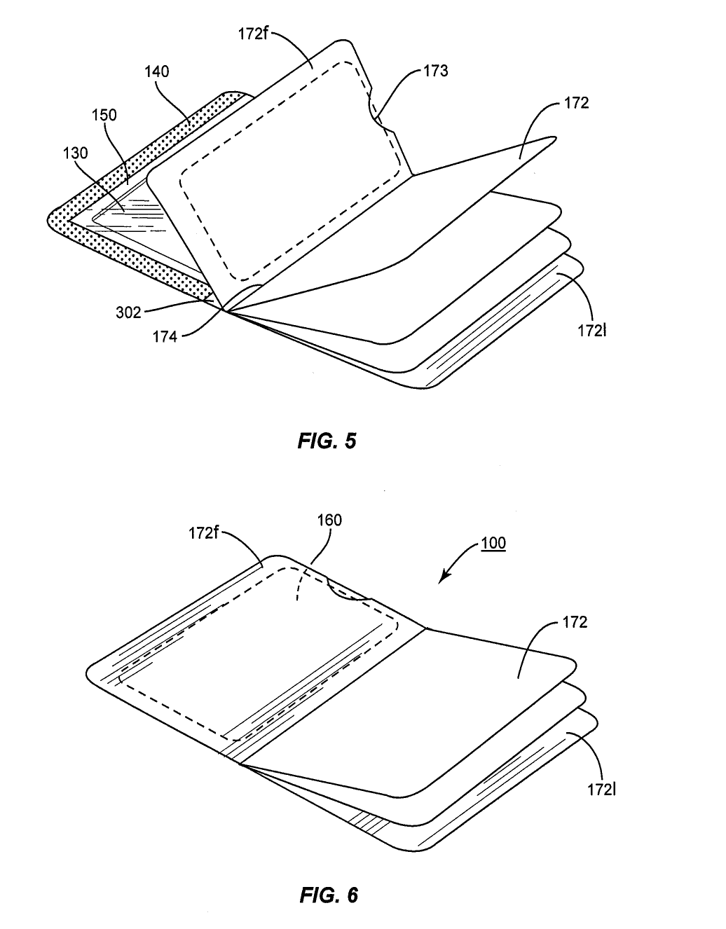

In the embodiments shown in FIGS. 1 through 6, a generally rectangular window opening 130 is die cut in the front cover panel 123. The window opening 130 is generally rectangular, and in one embodiment is dimensioned so that substantially all of the information on the front of a conventional bank card is visible without having to open and/or remove the bank card from the pocket within the booklet 100. In this embodiment, as illustrated in FIG. 2, the window opening 130 is about 1⅞ inches in width, WW, and about 2⅞ inches in height, WH, with a ⅛ inch radius on the corners. The window opening 130 may be die cut when the cover 120 is originally formed or may be cut thereafter as production efficiencies so dictate.

Turning now to FIG. 3, the inside surface 124 of the front cover panel 123 is best illustrated. Once the cover 120 has been formed and a window opening 130 cut therefrom the front cover panel 123 of the cover 120, an adhesive layer 140 may be applied to one or both inner surfaces. The adhesive layer may comprise any adhesive which is compatible with the cover 120 stock material. In one embodiment, the adhesive layer 140 is formed from a resin emulsion adhesive (for example, Har No. H3805-RN, Har Adhesive Corp., Bedford, Ohio). This adhesive comprises a vinyl acetate ethylene copolymer emulsion. The adhesive may include other additives, for example, a defoamer, for the desired finished cover/surface properties. The copolymer emulsion is water-based and contains approximately 45% water, and the vinyl acetate ethylene copolymer emulsion content is approximately >95.0 wt. %. It is contemplated, however, that any comparable adhesive may be used to form the adhesive layer 140. In the embodiments shown herein, the adhesive layer 140 is uniformly applied over the entire inside surface of the front cover panel 123, and over the entire inner surface of the rear cover panel 127.

Following application of the adhesive layer 140, a transparent sheet 150 is applied atop the adhesive layer 140 on the inner surface of the front cover panel 123 to form the window 131. To address the problem of static electricity, and thus reducing or eliminating the magnetic interruptions or alterations to bank and smart cards, the transparent sheet 150 is a clear, 5 mil, anti-static polyester sheet, from RIS Paper Co., item number 196713. In this embodiment, the transparent sheet 150 has a thickness of about 5 mils, however, the thickness of the sheet is not critical to the embodiments. As shown in the view of the inner surface of the front cover panel 123 of FIG. 3, the transparent sheet 150 is cut larger than the window opening 130, but is shorter and narrower than the front cover panel 123. In one embodiment, the transparent sheet is about 2 9/32 to 2 11/32 inches wide, SW, and about 3 5/16 to 3 7/16 inches in height, SH. As shown in FIG. 3, one side edge 150a is positioned adjacent the fold 122, and the upper edge 150b is positioned adjacent the top edge of the inner surface. This leaves an L-shaped marginal adhesive area 142 along two adjacent edges of the inner surface. The size of the transparent sheet relative to the cover size is important because the marginal edge of adhesive material left determines the pocket size which must be able to retain the bank or other type card.

While the dimensions of the booklet itself, the window opening 130 (FIG. 4), and the transparent sheet may vary, the concept is that, in addition to the book being small enough to fit into a wallet compartment and large enough to carry a bank card, credit card, debit card, and the like, the window opening should be large enough to display the necessary information from the bank card or other type of card, yet the transparent sheet must leave a wide enough marginal edge as to properly secure the edges of the booklet pages making up the pocket. As used herein, the term “substantial portion of the bank card would be visible,” as used herein, means that the informational portion of the bank card would be visible, so that the card does not have to be removed to be useful.

As will be appreciated, in the preferred embodiment the marginal adhesive area is slightly less than about ⅛ inches in width along the lower edge of the front cover panel 123 and slightly less than about 3/16 inches in width along the side edge of the front cover panel 123. Once the transparent sheet 150 has been adhered over the adhesive layer 140 to form the window 130 (FIG. 1), the pocket 160 of the booklet 100 may be formed. The first step in forming the pocket 160 is preparing a booklet insert 170 for insertion in the cover 120.

As shown in FIGS. 4 through 6, the booklet insert 170 is a plurality of leaves 172 that are formed of a material that is different from the material forming the cover 120 and that is suitable for printing indicia thereon, either by pre-printing or by providing surfaces upon which the booklet user may print with a conventional writing instrument such as a pen or pencil. The leaves 172 have substantially the same dimensions as the dimensions of the cover 120 and are also divided by a transverse fold 174, thereby forming the pages. The leaves 172 of the booklet insert 170 may be bound together along the transverse fold 174 by any conventional means such as stitching, stapling, gluing, etc. The number, surface finish, and indicia thereon the leaves 172 is dependent upon the type and specific application of booklet 100.

Thus, the pocket is formed by sealing the first leaf 172f of the booklet insert 170 along two edges to the L-shaped marginal adhesive area 142 on the inner surface of the front panel 123 and the last leaf 1721 to the inner surface of rear panel 127. The third, side edge of the first leaf then lies sealed along the transverse fold 174 of the cover, and the fourth, upper edge of the first leaf 172f remains open. So formed, the transverse fold 122 of the cover 120 and the transverse fold 174 of the booklet insert are contiguous. An arcuate recess 173 is provided along the upper edge of the first leaf 172f to facilitate insertion and removal of a bank card. Again, as shown in FIG. 6, the last leaf 1721 of the booklet insert 170 is adhered over the adhesive layer 140 applied over the inner surface of the rear cover panel 127, thus completing the construction of the booklet 100.

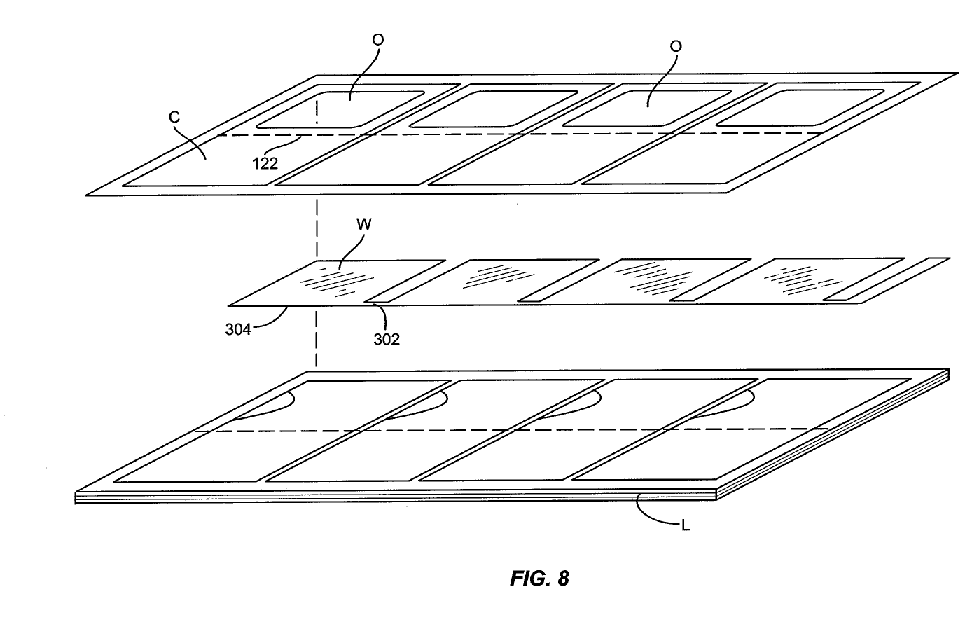

While the description above is appropriate to make booklets one at a time, FIG. 8 illustrates the method in which the present invention utilizes mass production techniques to more economically produce the windowed wallet size booklets illustrated in FIGS. 1-6. First, using a technique for producing four booklets at a time, a sheet of cover stock C having dimensions of approximately 6″×16½″ is die cut with four spaced window openings O. A plurality of sheets L which form the leaflets are placed on a table. The sheets are also approximately 6″×16½″ so that four booklets can be formed simultaneously. Obviously the back or rear sides of the sheets which form the first and last leaves are facing upwardly.

A sheet W of die cut, transparent, anti-static polyester or other polymers, which form the window coverings 150, is placed on the stack of leaflets as shown in FIG. 8. Each window covering is connected to the next window casing by a small connecting tab 302. In addition to connecting the window coverings to each other the tabs 302 space the lower edge of each window covering or sheet 150 from the lower edge of the booklet front cover panel 123 to form the lower leg of the L-shaped marginal adhesive area. See FIGS. 3 & 4.

The sheet W of die cut antistatic polyester is positioned atop the stack of leaflets (FIG. 8). The window covering sheet W is aligned within the stack of leaflets L and cover stock C in such a manner that the base 304 aligns with the fold line 122 of the booklets and the lower edge of each window covering will be spaced from the eventual lower edge of the booklet. The strip C of cover stock then passes by a roller which applies the adhesive to the undersurface. Then the cover stock is positioned appropriately above the leaflet stack L and transparent die cut sheet W and subjected to pressure to force the leaflet stack into engagement with the adhesive on the cover stock, wherein four booklets are formed. The booklets are folded, then cut to size with the corners rounded and separated. While the method described above is explained with respect to forming four booklets at a time, it is apparent that any plurality would be formed the same way.

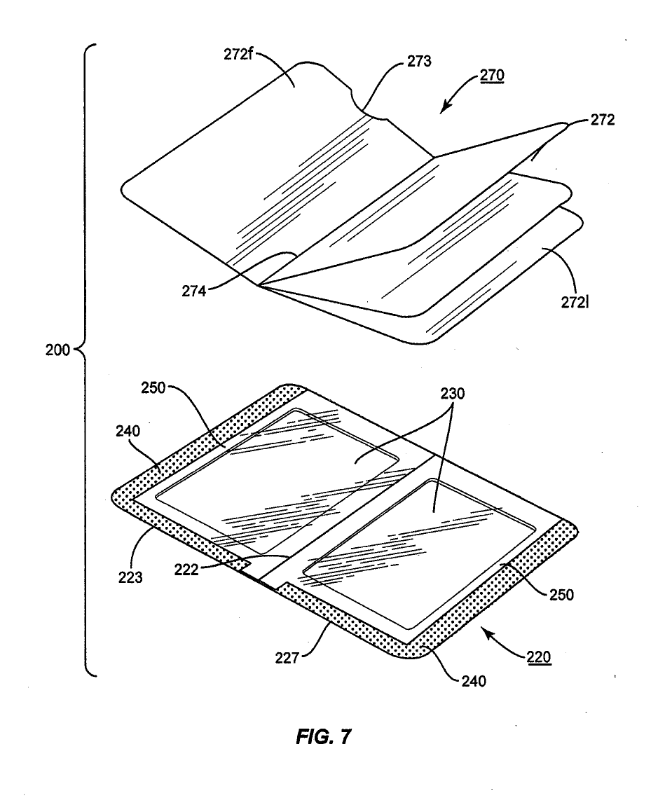

Turning lastly to FIG. 7, an alternative embodiment 200 of the booklet is illustrated. In this embodiment, windows 230 may be formed in both the front cover panel 223 and the rear cover panel 227 so that pockets may be formed for holding two bank cards. An adhesive layer 240 is applied in the same manner as described above, and transparent sheets 250 are adhered to the adhesive layer 240 on both panels 223, 227. Again, the cover 220 is folded along a transverse fold line 222 to correspond with the transverse fold line 274 of a booklet insert 270. In this embodiment, the first leaf 272f and last leaf 2721 are adhered to the respective L-shaped marginal adhesive areas to complete the pockets. The dimensions, transparent sheet, and method of construction for this embodiment are similar in all other respects to the booklet 100 described hereinabove.

The invention has been described herein in terms of several embodiments and constructions that are considered by the inventors to represent the best mode of carrying out the invention. It will be understood by those skilled in the art that various modifications, variations, changes and additions can be made to the illustrated embodiments without departing from the spirit and scope of the invention. These and other modifications are possible and within the scope of the invention as set forth in the claims.

What is claimed is:

1. A wallet size bank card booklet, comprising:
(a) a cover formed of a cover material having a width dimension ranging from about 4¾ inches to 5¼ inches and a height dimension ranging from about 3½ inches to 3⅝ inches, the cover further having a transverse fold which divides the cover into a front cover panel and a rear cover panel, each panel having outer and inner surfaces;
(b) a booklet insert in the form of a plurality of leaves formed of a different material from the cover and having dimensions substantially the same as the dimensions of the cover, the leaves also having a transverse fold, the leaves forming pages;
(c) the cover and booklet being attached in such a manner that the fold of the cover and fold of the leaves are contiguous;
(d) an opening in the front cover panel;
(e) an adhesive layer applied to at least the inner surface of the front cover panel;
(f) a transparent sheet adhered to the inner surface of the front cover panel, the transparent sheet being larger than the opening, but shorter and narrower than the front panel, thereby forming a window and having one side edge adjacent the fold, thereby leaving an L-shaped marginal adhesive area along two adjacent edges of the inner surface of the front panel;
(g) a pocket formed by a first leaf being sealed along two edges to the L-shaped marginal adhesive area on the inner surface of the front panel, with a third edge adjacent the fold and a forth edge remaining open; and
(h) wherein the pocket is of a large enough size to hold a conventional size bank card, but small enough to fit within the conventional card compartments of a wallet, and wherein a substantial portion of the bank card would be visible through the window on the front cover panel.

2. The wallet size bank card booklet of claim 1 wherein the transparent sheet is anti-static.

3. The wallet size bank card booklet of claim 2 wherein the transparent sheet is an anti-static clear polyester.

4. The wallet size bank card booklet of claim 1 wherein the window formed in the front cover panel is large enough to allow substantially all of the informational portion of a conventional bark card to be visible, but small enough to permit adherence of the first leaf to the L-shaped marginal adhesive area on the inner surface of the front panel.

5. The wallet size bank card booklet of claim 1 wherein the adhesive comprises a resin emulsion.

6. A method of forming a wallet size bank card booklet, comprising:
(a) forming a cover of cover material having a width dimension of between about 4¾ inches and 5¼ inches and a height dimension of between about 3⅜ inches and 3⅝ inches, the cover being divided into areas which eventually become a front cover panel and a rear cover panel divided by a transverse fold line, and an opening formed in portion of the cover which eventually becomes the front cover panel;
(b) applying an adhesive layer to at least the inner surface of the front cover panel;
(c) a window formed by adhering a transparent sheet to the inner surface of the front cover panel, the transparent sheet being larger than the opening, but shorter and narrower than the front panel, and having one side edge adjacent the fold, thereby leaving an L-shaped marginal adhesive area along two adjacent edges of the inner surface of the front panel;
(d) attaching a booklet insert in the form of a plurality of leaves formed of a different material from the cover and having dimensions substantially the same as the dimensions of the cover, the leaves also having a transverse fold, the cover and booklet being attached in such a manner that the fold of the cover and the fold of the leaves are contiguous;
(e) forming a pocket by sealing a first leaf of the plurality of leaves along two edges to the L-shaped marginal adhesive area on the inner surface of the front panel, with a third edge adjacent the fold and a forth edge remaining open; and
(f) wherein the pocket is of a large enough size to hold a conventional size bank card, but small enough to fit within the conventional card compartments of a wallet, and wherein a substantial portion of the bank card would be visible through the transparent sheet on the front cover panel.

7. The method of claim 6 further comprising the step of attaching the last leaf of the plurality of leaves to the inside surface of the rear cover panel.

8. A method of forming folded wallet size bank card booklets comprising the steps of:
(a) providing a strip of cover material at least equal in length to the combined height of a selected number of a plurality of unfolded booklets to be formed;
(b) forming a plurality of spaced window openings in the strip of cover material;
(c) stacking a plurality of leaflet sheets at least equal in length to the combined height of a selected number of a plurality of booklets face down on a surface;
(d) providing a die cut sheet of transparent polymeric material having an aligned row of spaced window coverings, the spacing of the window coverings corresponding to the spacing of the window openings in the strip of cover material, each window covering being greater in size than the corresponding window opening in the cover materials and smaller in size than the dimensions of the folded bank card booklet, whereby an adhesive area is formed along one side and the bottom of the rear surface of the portion of the cover material that will form the front cover, each window covering being connected to a waste strip by a tab of the polymeric material;
(e) positioning the polymeric sheet atop the stack of leaflets with each window covering being aligned with the portion of the corresponding leaflet sheet that will become a first leaflet sheet;
(f) applying adhesive to the rear surface of the cover strip;
(g) positioning the cover sheet atop the stack of leaflets in such manner that each section of the cover strip will align with one of the sections of the leaflets and the window opening will align with the window coverings;
(h) applying pressure to the stack of cover material, leaflets, and polymeric sheet whereby the polymeric window coverings adhere to the rear surface of the cover sheet around the window openings and the rear surface of the upper leaflet in the leaflet stack adheres to the remaining exposed adhesive coated portion of the rear surface of the cover material; and
(i) performing a cutting operation that cuts the booklets to size, separates the plurality of booklets, and cuts away the waste strip from the tab along the bottom edge of the strip of cover material.

9. The method according to claim 8 wherein, between steps (h) and (i), cover material and leaflets are folded.
